(19) United States
(12) Patent Application Publication
(10) Pub. No.: US 2018/0023783 A1
(43) Pub. Date: Jan. 25, 2018

(54) METHOD AND APPARATUS FOR SUBTENDING LIGHT DOWNWARDLY

(71) Applicant: JST Performance, LLC, Gilbert, AZ (US)

(72) Inventor: Edgar A. Madril, Mesa, AZ (US)

(73) Assignee: JST Performance, LLC, Gilbert, AZ (US)

(21) Appl. No.: 15/656,563

(22) Filed: Jul. 21, 2017

Related U.S. Application Data
(60) Provisional application No. 62/366,014, filed on Jul. 23, 2016.

(51) Int. Cl. F21V 13/04; F21K 9/69; F21V 7/05; F21V 7/09; F21V 7/06; F21K 9/68; F21V 5/04

(52) U.S. Cl. CPC F21V 13/04; F21K 9/68; F21K 9/69; F21V 5/043; F21V 7/09; F21V 7/06; F21V 7/05; F21Y 2115/10

(57) ABSTRACT

A lighting system may include a reflector having at least one surface forming an interior. The reflector may have a forward opening and a rearward opening. The lighting system may further include an LED positioned at the rearward opening to direct light through the interior of the reflector. The lighting system may further include a lens positioned within the reflector, wherein the lens is formed of a segment of a toroid.

### FIELD OF THE INVENTION

The present invention generally relates to lighting systems, and more particularly to a system for distributing light below a horizon line.

### BACKGROUND

Light emitting diodes (LEDs) have been utilized since about the 1960s. However, for the first few decades of use, the relatively low light output and narrow range of colored illumination limited the LED utilization role to specialized applications (e.g., indicator lamps). As light output improved, LED utilization within other lighting systems, such as within LED “EXIT” signs and LED traffic signals, began to increase. Over the last several years, the white light output capacity of LEDs has more than tripled, thereby allowing the LED to become the lighting system of choice for a wide range of lighting systems.

LED lighting systems have introduced other advantages, such as increased reliability, design flexibility, and safety. Lighting systems may be designed to optimize light distribution for a number of lighting applications, such as in fair or adverse weather conditions (e.g., dust, fog, rain, and/or snow). Further, the lighting system may be optimized to produce a particular beam pattern having suitable characteristics for a corresponding lighting application.

Efforts continue, therefore, to develop lighting systems having suitable beam patterns and/or characteristics which cater to the specific application for which it was intended.

### SUMMARY

In accordance with one embodiment of the invention, a lighting system comprises a reflector having at least one surface forming an interior, the reflector having a forward opening and a rearward opening, a light source configured at the rearward opening to emit light through the interior of the reflector, and a lens configured at the rearward opening, wherein the lens is formed of a segment of a toroid.

In accordance with another embodiment of the invention, a lighting system comprises a reflector having first, second, third, fourth, and fifth surfaces forming an interior, the reflector having a forward opening and a rearward opening, a light source configured at the rearward opening to emit light through the interior of the reflector, and a lens configured at the rearward opening, wherein light emitted by the light source is subtended by one or more of the first, second, third, fourth, and fifth surfaces and the lens.

In accordance with another embodiment of the invention, a lighting system comprises a housing, a reflector coupled to the housing, a frame element coupled to the reflector, and a media extending over the reflector, wherein the media exerts a force on the frame element, and wherein the frame element moves with respect to the reflector in response to the force.

### BRIEF DESCRIPTION OF THE DRAWINGS

Various aspects and advantages of the invention will become apparent upon review of the following detailed description and upon reference to the drawings in which:

FIG. 1 illustrates an isometric view of a lighting fixture secured to a vehicle, according to an embodiment of the present invention;

FIG. 2 illustrates an isometric view of the lighting fixture of FIG. 1;

FIG. 3 illustrates an isometric view of an optic assembly, including a reflector and a lens positioned on a PCBA to redirect light from a light source, according to another embodiment of the present invention;

FIG. 4 illustrates an isometric view of a first optic assembly and a second optic assembly arranged in series;

FIG. 5A illustrates a cross-sectional view of the optic assembly of FIG. 3;

FIG. 5B illustrates a cross-sectional view of the optic assembly of FIG. 3;

FIG. 6A illustrates a front side view of the reflector of FIG. 3;

FIG. 6B illustrates a top side cross-sectional view of the reflector of FIG. 3;

FIG. 6C illustrates a right side cross-sectional view of the reflector of FIG. 3;

FIG. 7A illustrates a front side view of the lens of FIG. 3;

FIG. 7B illustrates a top side view of the lens of FIG. 3;

FIG. 7C illustrates a right side cross-sectional view of the lens of FIG. 3;

FIG. 8A illustrates an isometric view of an optic assembly secured to a frame element, according to another embodiment of the present invention;

FIG. 8B illustrates a cross-sectional view of the optic assembly and frame element of FIG. 8A secured within an optic surround between a media and a housing of a lighting fixture;

FIG. 9 illustrates a top side cross-sectional view of the reflector of FIG. 3;

FIG. 10 illustrates a enlarged top side view of the lens of FIG. 3; and

FIG. 11 illustrates an isocandela plot of a beam pattern produced by the optic assembly of FIG. 3;

FIG. 12 illustrates a top side cross-sectional view of a reflector, according to another embodiment of the present invention.

### DETAILED DESCRIPTION

Generally, the various embodiments of the present invention are applied to an apparatus and a method of distributing light. Specifically, the present invention is a lighting system that emits light in a forward and downward direction (e.g., below a horizon). Light emitted from an LED may be subtended by a reflector, a lens, or both, into a subtended span of light. The LED may have an axis of symmetry extending symmetrically through an effective span of emission, such that the axis of symmetry extends in a forward direction of the lighting system (e.g., substantially horizontally). The lens and the reflector may be positioned within a housing of the lighting system such that a plane of symmetry of the reflector and a principal optical axis of the lens are inclined with respect to the axis of symmetry of the LED (e.g., such that the subtended span of light passes forwardly and downwardly from the lighting system).

The LED may be integrated into a printed circuit board assembly (PCBA) that includes control circuitry to provide intermittent or controlled power to the LED. For example, the LED may emit light when power is supplied by the control circuitry. For example, light may be emitted at one or more power levels, or light may be emitted intermittently or repeatedly.

The reflector may be coupled to the PCBA. For example, the reflector may contact the PCBA, and/or be attached therewith by means of an attachment mechanism. The reflector may have one or more sides, and further may include a forward opening and a rearward opening. The rearward opening may be positioned adjacent the PCBA. The LED may extend into the rearward opening, or may be spaced therefrom by a predetermined distance. The reflector may be positioned so that all or substantially all light emitted by the LED passes into an interior of the reflector before passing forwardly of the lighting system.

The lens may be coupled to the reflector, the PCBA, or both. For example, the lens may contact and/or be attached to the reflector, the PCBA, or both. The lens may be positioned near the rearward opening of the reflector. Further, the lens may be positioned to cover or substantially cover the LED. Further, the lens may be positioned to cover or substantially cover the light-emitting portion of the LED. The lens may include a portion or a segment of a toroid. For example, the segment of the toroid may include an arc portion of the toroid. In another example, the segment of the toroid may include a particular cross-section.

Light emitted by the LED may be directed forwardly from the PCBA. For example, light may be emitted into four zones of light ray emission. One zone of light ray emission may consist of light reflected by a top surface of the reflector only. One zone of light ray emission may consist of light reflected by a bottom surface of the reflector only. One zone of light ray emission may consist of light refracted by the lens. One zone of light ray emission may consist of light not reflected nor refracted. Other zones of light ray emission may exist. Each zone of light ray emission may be designed to cause light to be distributed in a forward and downward direction. Thus, light distributed by the light system may produce a beam pattern entirely or predominantly below a horizontal line (e.g., below the axis of symmetry of the LED). Further, the beam pattern may be in compliance with certain federal and/or industry standards.

The reflector may be formed of one or more parabolic surfaces and/or one or more flat surfaces. The parabolic surface(s) of the reflector may be positioned such that the plane of symmetry of the reflector corresponds to a plane of symmetry of the parabolic surface. The reflector may be positioned such that light subtended by the reflector is subtended downward. The lens may be formed of a segment of a toroid. The segment of the toroid may be positioned within the reflector, and may extend across a distance in front of the LED. The LED may be positioned with respect to the principal optical axis of the lens so that light refracted through the lens is subtended downward. A small portion of emitted light may pass beyond the reflector and the lens without being subtended.

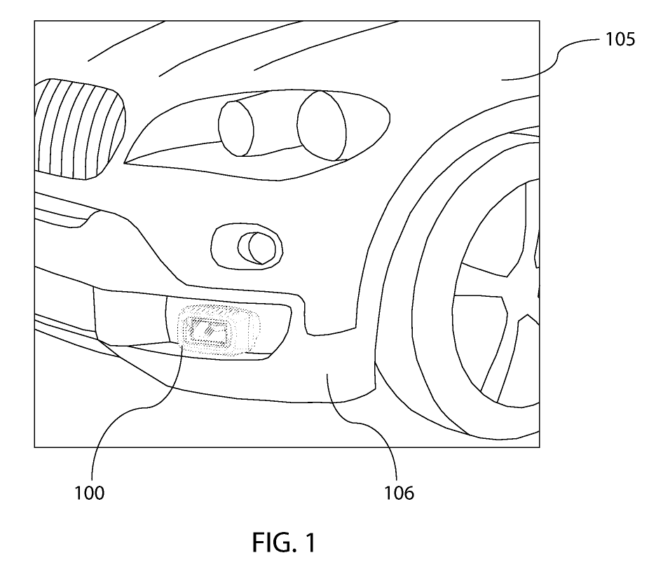

FIG. 1 illustrates an isometric view of a lighting fixture 100 secured to a vehicle 105 and/or to a structural element 106 (e.g., a bumper) of vehicle 105, according to an embodiment of the present invention. For example, lighting fixture 100 may be mounted directly (e.g., flush-mounted via a flange extending from lighting fixture 100), indirectly (e.g., via a mounting bracket extending from lighting fixture 100), or both.

Structural element 106 may be a component of a land vehicle (e.g., an automobile), marine vehicle (e.g., a fishing boat, or air vehicle (e.g., a hovercraft). For example, structural element 106 may be any one or more of a bumper, a grille, a roll-bar, another lighting fixture, a frame, a body panel, or any other element suitable for mounting the lighting fixture 100.

Lighting fixture 100 may receive electrical power from a power source (e.g., a battery of vehicle 105 not shown). Lighting fixture 100 may convert the electrical power into visible and/or nonvisible radiation (e.g., visible light rays), which may be emitted and/or directed from lighting fixture 100. For example, lighting fixture 100 may illuminate an area and/or a ground portion in the vicinity of vehicle 105 (e.g., illuminating the ground and terrain existing forwardly of vehicle 105).

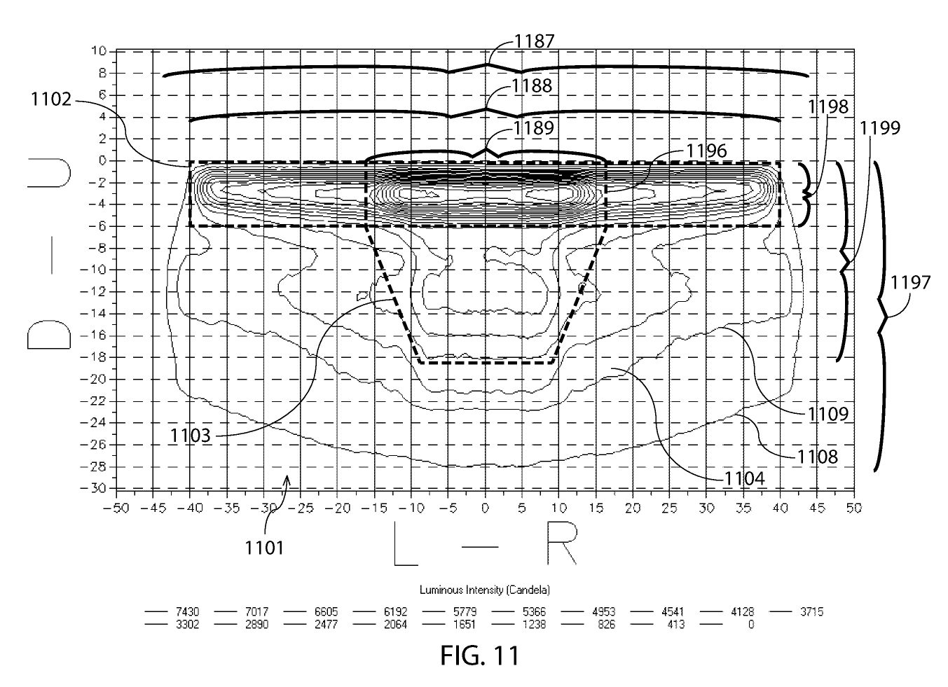

Light emitted from lighting fixture 100 may be directed within a beam pattern designed to have one or more characteristics. For example, a characteristic may include compliance with industry standards, government regulations, or both. In another example, a characteristic may be light produced at and/or above a specified intensity (e.g., within a particular region of the beam pattern). In another example, a characteristic may be light produced at and/or below a specified intensity (e.g., within a particular region of the beam pattern). In another example, a characteristic may be light directed within a specified range and/or directed to emit light toward one or more specified locations (e.g., below a horizontal plane). In another example, the beam pattern may include a distribution of light having a particular gradient along a specified vector through the beam pattern (e.g., as exemplified in FIG. 11).

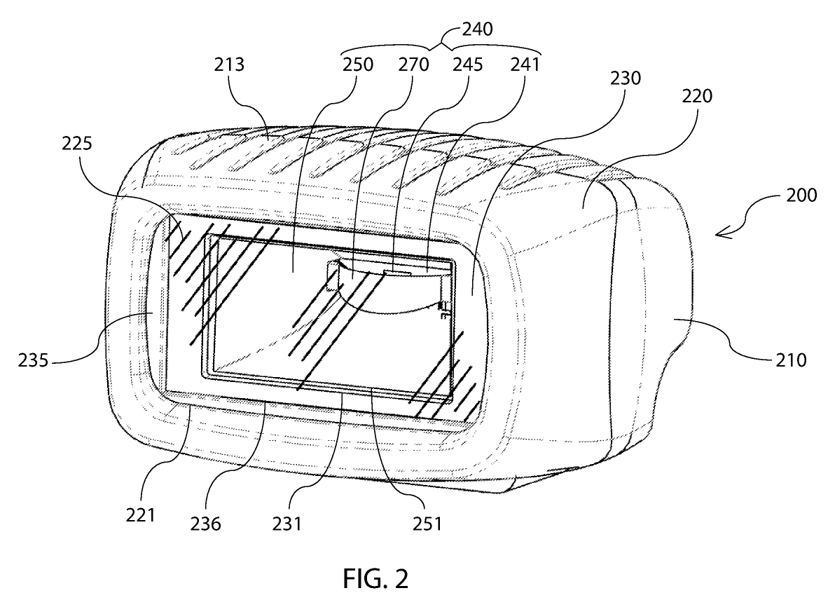

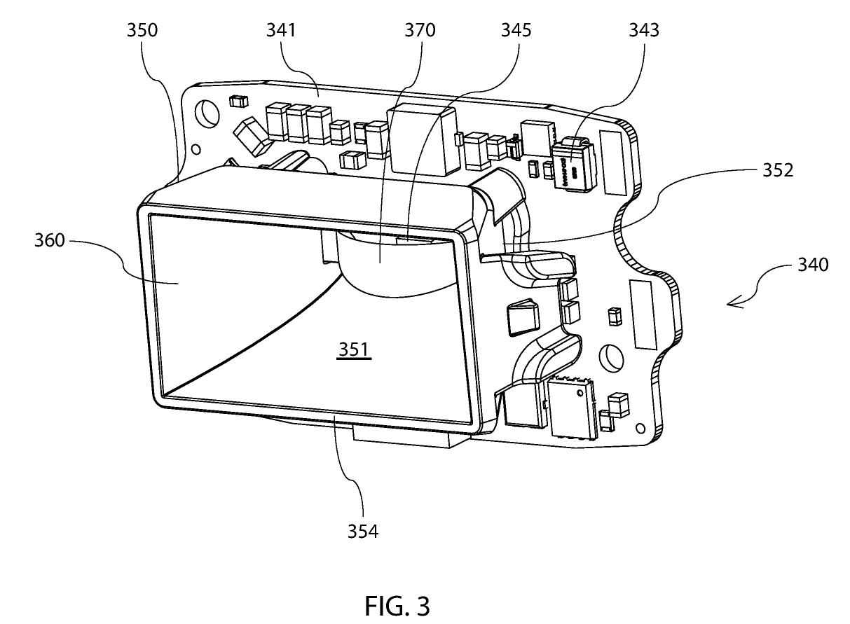

FIG. 2 illustrates an isometric view of a lighting fixture 200. Lighting fixture 200 may include a housing 210 with an opening 211 for containing one or more optic assemblies 240 therein. Optic assembly 240 may include one or more PCBAs 241 with control circuitry (e.g., control circuitry 343 of FIG. 3) for regulating power to one or more LEDs 245 positioned on PCBA 241. PCBAs 241 may receive power and/or control signals from a cable (not shown) extending from a battery (not shown). LEDs 245 may emit light rays by converting electrical power into visible and/or nonvisible radiation (e.g., visible rays of light). Further, the light rays may be emitted within a span of emission of LEDs 245 (e.g., with an axis of symmetry extending substantially forwardly of housing 210 through opening 211).

During operation, the PCBAs 241 and/or LEDs 245 may generate heat as a byproduct of the conversion of electrical power into radiation. Housing 210 may be capable of dissipating heat away from PCBAs 241 and/or LEDs 245 (e.g., via conduction). For example, housing 210 may be formed a material selected to optimize performance characteristics (e.g., thermal transfer coefficient). In another example, housing 210 may include one or more features (e.g., fins 213) which increase a surface area of housing 210 to enhance heat dissipation away from housing 210 (e.g., via convection).

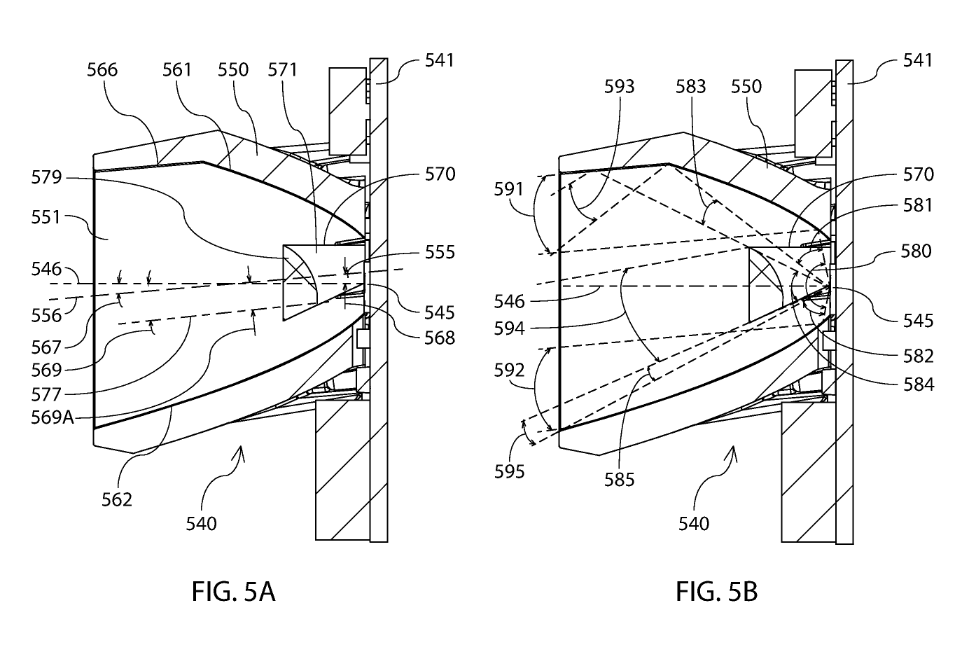

Optic assembly 240 may include a reflector 250 positioned to subtend a portion of the light rays emitted by LEDs 245 (e.g., into span 581 of FIG. 5). In order to subtend light, reflector 250 may include an opening 251 extending therethrough, which may be formed of one or more reflective surfaces (e.g., reflective surface 561 of FIG. 5). Reflector 250 may be secured to one or more of housing 210 and/or PCBA 241.

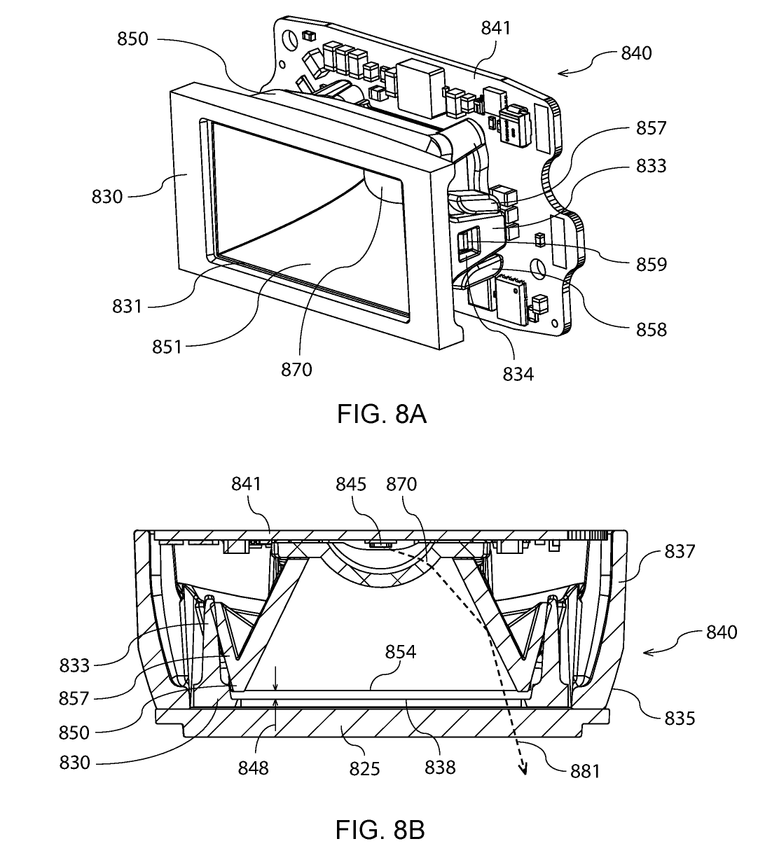

Optic assembly 240 may include a lens 270 positioned to subtend a portion of the light rays emitted by LEDs 245 (e.g., into span 584 of FIG. 5). Lens 270 may be secured to one or more of housing 210, reflector 250, and/or PCBA 241. A portion of the light rays may extend through opening 251 of reflector 250 and/or opening 211 of housing 210 without being subtended by lens 270 and reflector 250 (e.g., into span 585 of FIG. 5). Furthermore, a portion of light may be subtended by both lens 270 and reflector 250 (e.g., light ray 881 of FIG. 8B).

A frame element 230 may be secured over reflector 250 to enable securement of reflector 250 without compression and/or deformation of reflector 250. Frame element 230 may include an opening 231 positioned to be substantially aligned with opening 251 of reflector 250. Further, frame element 230 may be secured to one or more of housing 210, reflector 250, and/or PCBA 241.

An optic surround 235 may be secured over reflector 250 and/or frame element 230 to enable securement of reflector 250 without compression and/or deformation of reflector 250. For example, optic surround 235 may be formed integrally with and/or separately from frame element 230. Optic surround 235 may include an opening 236 positioned to be substantially aligned with opening 231 of frame element 230 and/or opening 251 of reflector 250. Further, optic surround 235 may be secured to one or more of housing 210, reflector 250, frame element 230, and/or PCBA 241.

A bezel 220 and a media 225 may be secured over optic assembly 240, optic surround 235, and/or frame element 230 to enclose and/or seal opening 211 of housing 210 (e.g., via a gasket, not shown) and protect the PCBAs 241 and LEDs 245 from moisture and/or other contaminants. Bezel 220 may have an opening 221 positioned to be substantially aligned with opening 231 of frame element 230, opening 236 of optic surround 235, and/or opening 251 of reflector 250. Further, bezel 220 may be secured to housing 210 (e.g., via fasteners, not shown).

Media 225 may extend across opening 221 of bezel 220 and may enclose and/or seal opening 221 (e.g., via a gasket, not shown). Further, media 225 may extend between bezel 220 and one or more of optic assembly 240, optic surround 235, and/or frame element 230, such that securement of bezel 220 to housing 210 may cause media 225 to be compressed between bezel 220 and one or more of optic assembly 240, optic surround 235, and/or frame element 230. Media 225 may be formed of a material selected to optimize performance characteristics (e.g., durability, diaphaneity, and/or diffusivity). For example, media 225 may be transparent, translucent, and/or opaque.

FIG. 3 illustrates an isometric view of an optic assembly 340, including a reflector 350 and a lens 370 positioned on a PCBA 341 to redirect light emitted by a light source 345 (e.g., one or more LEDs) on the PCBA 341. The PCBA 341 may include control circuitry 343 for regulating power provided to the light source 345. For example, control circuitry 343 may enable light source 345 to be operated in one or more modes of operation (e.g., full power, half power, intermittent power, off, etc.).

Reflector 350 may include an opening 351 for subtending (e.g., reflecting) light emitted by light source 345 into opening 351. For example, opening 351 may have a rearward end 352 positioned adjacent PCBA 341 and a forward end 354 positioned oppositely of rearward end 352, such that opening 351 may be formed by one or more reflective surfaces 360 extending between the rearward and forward openings 352, 354. For example, reflective surfaces 360 may include one or more of a flat surface, a curved surface, a convex surface, a concave surface, a spherical surface, a parabolic cup, and/or a parabolic trough.

Light source 345 may be oriented such that light may be emitted substantially away from PCBA 341 (e.g., with an axis of symmetry of the emitted light which is perpendicular to PCBA 341). Further, a portion of the emitted light may be subtended by reflector 350 (e.g., reflected light), a portion of the emitted light may be subtended by lens 370 (e.g., refracted light), a portion of the emitted light may not be subtended by either reflector 350 or lens 370 (e.g., spill light), and/or a portion of the emitted light may be subtended by both lens 370 and reflector 350. The combination of the subtended light and/or non-subtended light may combine to form a beam pattern which satisfies industry standards, government regulations, or both. For example, where optic assembly 340 is incorporated into a lighting fixture (e.g., lighting fixture 100 of FIG. 1) for use as a fog light, the beam pattern produced by optic assembly 340 may satisfy harmonized standards for front fog lamps, such that the lighting fixture may be installed on any vehicle (e.g., vehicle 105 of FIG. 1) in any country having adopted the SAE J583 standard (e.g., the United States) or the ECE R19 standard (e.g., Europe).

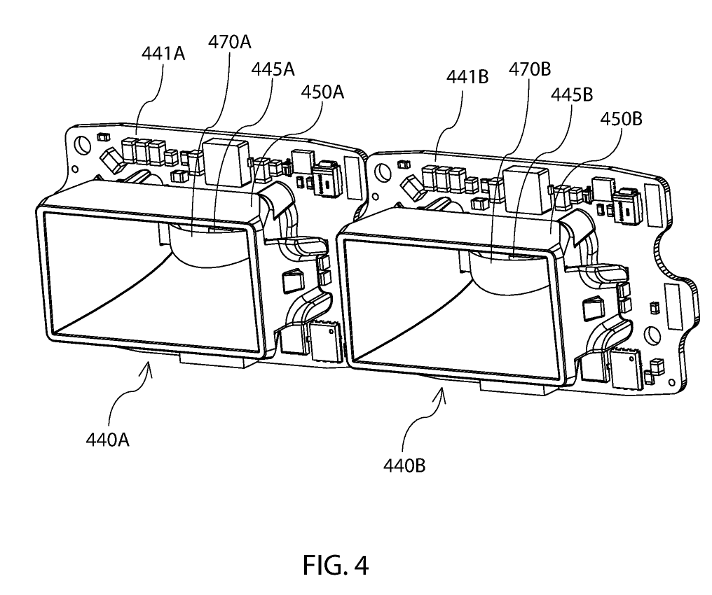

FIG. 4 illustrates an isometric view of a first optic assembly 440A and a second optic assembly 440B arranged in series (e.g., a side-by-side configuration). Each optic assembly 440A, 440B may have a PCBA (e.g., PCBAs 441A, 441B), a light source (e.g., light sources 445A, 445B), a reflector (e.g., reflectors 450A, 450B), and a lens (e.g., lenses 470A, 470B). Further, each optic assembly 440A, 440B may operate independently, interdependently, and/or collectively of/with the other optic assembly.

While only two optic assemblies have been illustrated in FIG. 4, a person of ordinary skill in the art will appreciate that additional optic assemblies may be arranged in series with first and second optic assemblies 440A, 440B (e.g., in a series of 3, 4, 5, 6, 7, 8, 9, or more optic assemblies). Furthermore, while first and second optic assemblies 440A, 440B have been illustrated in a side-by-side relationship, a person of ordinary skill in the art will appreciate that optic assemblies may be arranged in a top-bottom series, and further in an array of optic assemblies (e.g., a 2×2 array of optic assemblies). Each series and/or array of optic assemblies may be assembled within one or more lighting fixtures with an opening sized to receive the series and/or array of optic assemblies.

FIG. 5A and 5B illustrate cross-sectional views of an optic assembly 540 including a reflector 550, a lens 570, and a light source 545 (e.g., one or more LEDs) positioned on a PCBA 541 to produce a combination of subtended and non-subtended light. Light source 545 may emit light in a span of emission 580 (e.g., a span including spans 581-585, of FIG. 5B) with an axis of symmetry (e.g., axis of symmetry 546, of FIG. 5A) corresponding to the span of emitted light. Axis of symmetry 546 may extend substantially perpendicularly to PCBA 541 (e.g., as exemplified in FIG. 5A). For example, axis of symmetry 546 may extend through lens 570 and/or may extend through an opening 551 of reflector 550.

Reflector 550 may include one or more reflective surfaces (e.g., first and second surfaces 561, 562) for collimating, focusing, and/or diffusing light emitted by light source 545. The reflective surfaces may be flat, curved, convex, concave, spherical, and/or parabolic. For example, first surface 561 may be formed by a first parabola projected along a distance to form a parabolic trough. In another example, second surface 562 may be formed by a second parabola projected along a distance to form a parabolic trough.

In another example, first and second surfaces 561, 562 may be formed by a single parabola projected along a distance to form a single parabolic trough. The single parabola may have a focal point, which when projected along the distance, may create a principal focal axis 555 (e.g., extending into and out of the page of FIG. 5A). Accordingly, first and second surfaces 561, 562 and the single parabolic trough may have a common focal axis (e.g., principal focal axis 555). Further, the single parabola may have an axis of symmetry (e.g., corresponding to a principal optical axis of the parabola), which when projected along the distance, may create a plane of symmetry 556 (e.g., extending into and out of the page of FIG. 5A). Accordingly, portions of first and second surfaces 561, 562 may be symmetrical across the plane of symmetry 556. Nevertheless, first and second surfaces 561, 562 may not be perfectly symmetrical (e.g., representing different segments of the parabolic trough).

The single parabolic trough formed by first and second surfaces 561, 562 may be rotated about the principal focal axis 555 such that the plane of symmetry 556 of first and second surfaces 561, 562 may have an incline 567 with respect to the axis of symmetry 546 of light source 545. For example, incline 567 may be between about −20 degrees and about 20 degrees (e.g., about −1 degrees). Thus, where the axis of symmetry 546 of light source 545 is horizontal (e.g., perpendicular to PCBA 541), an incline of the plane of symmetry 556 that is less than 0 degrees (e.g., a negative incline) may correspond to a downward rotation of light subtended by reflector 550 (e.g., toward the ground), and an incline greater than 0 degrees (e.g., a positive incline) may correspond to an upward rotation of light subtended by reflector 550 (e.g., into the air). A person of ordinary skill in the art will appreciate the significance and impact of a rotation of reflector 550 on the resulting beam pattern produced by emitted light. Thus, where it is desirable to emit light into a particular beam pattern and/or photometric distribution, a reflector may be rotated about its principal focal axis to subtend light into the desired and/or designed for beam pattern.

The reflector formed by first and second surfaces 561, 562 (e.g., a single parabolic trough) may have an offset 568 in one or more directions such that the axis of symmetry 546 of light source 545 does not intersect the principal focal axis 555 of first and second surfaces 561, 562 (e.g., the axis of symmetry 546 of light source 545 may be offset with respect to the principal focal axis of the parabola). For example, the principal focal axis 555 may be offset in a direction perpendicular to the axis of symmetry 546 of light source 545. In another example, the principal focal axis 555 may be offset in a direction both perpendicular to the axis of symmetry 546 of light source 545 and perpendicular to the principal focal axis 555.

In another example, the principal focal axis 555 may be offset to be below the axis of symmetry 546 of light source 545 (e.g., a negative offset). In another example, the principal focal axis 555 may be offset to be above the axis of symmetry 546 of light source 545 (e.g., a positive offset). Thus, a negative offset of principal focal axis 555 may correspond to an upward rotation of light subtended by reflector 550 (e.g., into the air), and a positive offset of principal focal axis 555 may correspond to a downward rotation of light subtended by reflector 550 (e.g., toward the ground). In another example, offset 568 may be between about −0.1 inches and about 0.1 inches (e.g., about 0.0236 inches). Nevertheless, offset 568 may vary depending on the size of the light source, the reflector, and/or the lens (e.g., offset 568 may be scalable with a scaling of other components of optic assembly 540).

Lens 570 may include a refractive portion 571 extending across light source 545, such that a portion of light emitted by light source 545 may be subtended by the refractive portion 571 of lens 570. For example, the axis of symmetry 546 of light source 545 may pass through refractive portion 571. Refractive portion 571 may have a particular cross-sectional shape 579 to optimize subtending of light therethrough. For example, the cross-sectional shape of refractive portion 571 may be polygonal (e.g., triangular), circular, and/or ovular. In another example, the cross-sectional shape of refractive portion 571 may be a segment of a polygon, a segment of a circle (e.g., as exemplified in FIG. 5A), and/or a segment of an oval (e.g., as exemplified in FIG. 5B).

Refractive portion 571 of lens 570 may include a principal optical axis 577. Where refractive portion 571 has a segmented cross-section, the principal optical axis 577 may extend above, below, or through the segmented cross-section. For example, principal optical axis 577 of refractive portion 571 may be collinear and/or parallel to axis of symmetry 546 of light source 545. In another example, principal optical axis 577 may be at an incline 569 with respect to axis of symmetry 546 of light source 545. For example, principal optical axis 577 may be between about −20 degrees and about 20 degrees (e.g., about −1 degrees). Thus, where the axis of symmetry 546 of light source 545 is horizontal (e.g., perpendicular to PCBA 541), an incline of the principal optical axis 577 that is less than 0 degrees (e.g., a negative incline) may correspond to a downward rotation of light subtended by reflector 550 (e.g., toward the ground), and an incline greater than 0 degrees (e.g., a positive incline) may correspond to an upward rotation of light subtended by reflector 550 (e.g., into the air).

In another example, principal optical axis 577 of refractive portion 571 may be collinear and/or parallel to plane of symmetry 556 of reflector 550. For example, principal optical axis 577 may be below plane of symmetry 556 of reflector 550 (e.g., a negative offset 569A). In another example, principal optical axis 577 may be above plane of symmetry 556 of reflector 550 (e.g., a positive offset). Thus, a negative offset of principal optical axis 577 may correspond to a downward rotation of light subtended by reflector 550 (e.g., toward the ground), and a positive offset of principal optical axis 577 may correspond to an upward rotation of light subtended by reflector 550 (e.g., into the air). In another example, offset 569 may be between about −0.1 inches and about 0.1 inches (e.g., about 0.0236 inches). Nevertheless, the offset may vary depending on the size of the light source, the reflector, and/or the lens (e.g., offset 569A may be scalable with a scaling of other components of optic assembly 540).

In accordance with the above descriptions, reflector 550 (e.g., the single parabolic trough formed by first and second surfaces 561, 562) may be both rotated and offset, and the lens 570 may be offset simultaneously. For example, reflector 550 (e.g., the single parabolic trough) may first be rotated about principal focal axis 555 with a negative incline, and may second be shifted with a positive offset such that the principal focal axis 555 may be located above the light source 545 and/or axis of symmetry 546, with the refractive portion 571 of lens 570 shifted with a negative offset such that the principal optical axis 577 of refractive portion 571 may be located below light source 545 and/or the axis of symmetry 546 of light source 545. The combination of the rotation and offset of reflector 550 (e.g., first and second surfaces 561, 562), and the offset of lens 570, may each cause a downward rotation of light subtended by reflector 550 and lens 570 (e.g., toward the ground), such that light is subtended by reflector 550 and lens 570 into a particular beam pattern (e.g., below a horizontal delineation and/or below axis of symmetry 546). A person of ordinary skill in the art will appreciate that other combinations of rotations and offsets may be possible to optimize light subtended by reflector 550 and lens 570 in order to produce a beam pattern having particular characteristics, a particular photometric distribution of light, and/or a particular intensity gradient.

As illustrated in FIG. 5B, light source 545 may emit light in a span of emission 580 (e.g., a span including spans 581-585). For example, span of emission 580 of light source 545 may be between about 120 degrees and about 220 degrees (e.g., about 180 degrees). In another example, span of emission 580 may represent an effective span (e.g., a span including substantially all of the light emitted) of light source 545, which may be smaller than the actual span of emitted light. Portions of span of emission 580 may be subtended (e.g., producing subtended light 591), and/or may pass from the optic assembly 540 without being subtended (e.g., producing spill light 585).

For example, a first span 581 of emitted light 580 may be subtended (e.g., reflected) by first surface 561 of reflector 550, and may produce subtended light 591. In another example, a second span 582 of emitted light 580 may be subtended (e.g., reflected) by second surface 562 of reflector 550, and may produce subtended light 592. Light subtended by first and second surfaces 561, 562 (e.g., reflected light 591, 592) may pass from reflector 550 with an incline corresponding to incline 567 (e.g., in a direction corresponding to the plane of symmetry 556 and/or the direction of a principal optical axis of reflector 550). Thus, where reflector 550 has been rotated with a negative incline, and/or shifted with a positive offset, subtended light 591, 592 may be subtended in a forward and downward direction upon exiting reflector 550.

In another example, a third span 583 of emitted light 580 may be subtended (e.g., reflected) by a third surface 566 of reflector 550, and may produce subtended light 593. It may be desirable for all light exiting reflector 550 to pass in a downward direction (e.g., below the horizontal), such that the optic assembly 540 may be used in a particular lighting fixture (e.g., in a fog light satisfying the SAE J583 and ECE R19 standards). For example, third surface 565 may be flat, curved, convex, concave, spherical, parabolic, or any other suitable shape to prevent third span 583 from exiting reflector 550 without being subtended (e.g., so as not to escape as spill light). In another example, third span 583 may be emitted by light source 545 with a positive incline (e.g., upwardly from axis of symmetry 546 of light source 545), and third surface 566 may subtend span 583 to produce subtended light 593 with a negative incline (e.g., downwardly from the axis of symmetry 546 of light source 545).

In another example, a fourth span 584 of emitted light 580 may be subtended (e.g., refracted) by refractive portion 571 of lens 570, and may produce subtended light 594. Light subtended by refractive portion 571 (e.g., subtended light 594) may pass from lens 570 with an incline corresponding to incline 569 between the principal optical axis 577 of lens 570 and the axis of symmetry 546 of light source 545. For example, an increasingly negative offset of principal optical axis 577 below axis of symmetry 546 may cause an increasingly negative incline of subtended light 594, and an increasingly positive offset of principal optical axis 577 above axis of symmetry 546 may cause an increasingly positive incline of subtended light 594. It may be desirable for all light exiting reflector 550 to pass in a forward and downward direction (e.g., below the horizontal), therefore, subtended light 594 may be negatively inclined by offsetting or inclining principal optical axis 577 to be below axis of symmetry 546.

In another example, a fifth span 585 of emitted light 580 may pass from optic assembly 540 without being subtended (e.g., by either reflector 550 or lens 570), and may produce spill light 595 (e.g., light exiting reflector 550 without being subtended). For example, span 585 may be emitted by light source 545 with a negative incline (e.g., downwardly from axis of symmetry 546 of light source 545), and may require no subtending to pass from reflector 550 as spill light 595. In another example, span 585 may be emitted by light source 545 with a positive incline (e.g., upwardly from axis of symmetry 546 of light source 545). In another example, reflector 550 and lens 570 may be configured to prevent any spill light from exiting the optic assembly 540.

In accordance with the above examples, the first-fourth spans 581-584 may each be individually subtended to produce subtended light 591-594, and the fifth span 585 may pass without being subtended to produce spill light 595. The subtended light 591-594 and spill light 595 may combine to produce a particular beam pattern (e.g., beam pattern 1101 of FIG. 11), a particular photometric distribution, and/or a particular intensity gradient, which may be harmonized to satisfy multiple standards (e.g., the SAE J583 and ECE R19 standards). A person of ordinary skill in the art will appreciate that subtended and non-subtended light may be combined in additional configurations to produce other useful beam patterns.

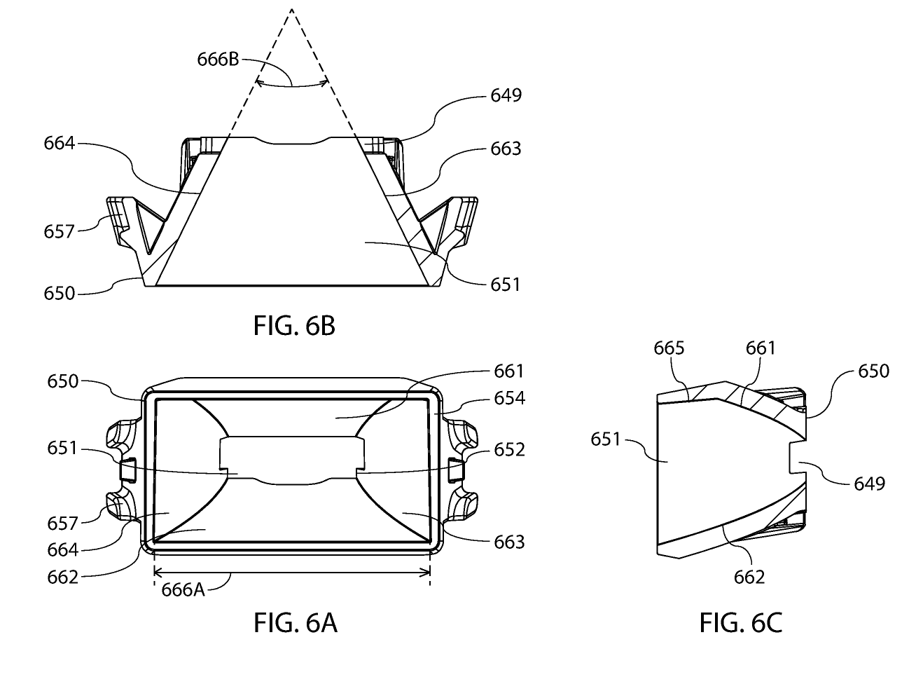

FIGS. 6A-6C illustrate various views of a reflector 650 having an opening 651 formed by one or more reflective surfaces (e.g., surfaces 661, 662, 663, 664, 665) for subtending light from a light source (e.g., light source 345 of FIG. 3). For example, opening 651 may have a rearward perimeter 652 and a forward perimeter 654, and the one or more reflective surfaces may extend at least partially between the rearward and forward perimeters 652, 654. In another example, a first surface 661 may extend from the rearward perimeter 652 to an intermediate surface 665, and intermediate surface 665 may extend to forward perimeter 654. In another example, a second surface 662 may extend between the rearward and forward perimeters 652, 654. In another example, a third surface 663 may extend between the rearward and forward perimeters 652, 654. In another example, a fourth surface 664 may extend between the rearward and forward perimeters 652, 654.

Each of the one or more reflective surfaces may be flat, curved, convex, concave, spherical, and/or parabolic to enable collimation, focusing, and/or diffusion of light therefrom. For example, first and second surfaces 661, 662 may be parabolic (e.g., formed of a single parabolic trough). In another example, third and fourth surfaces 663, 664 may be flat. In another example, third and fourth surfaces 663, 664 may be spaced a distance from each other at the forward perimeter (e.g., having distance 666A). Distance 666A may be between about 0.5 inches and about 5 inches (e.g., about 2 inches). In another example, third and fourth surfaces 663, 664 may be angled with respect to each other (e.g., having angle 666B). Angle 666B may be between about 20 degrees and about 90 degrees (e.g., about 60 degrees). A person of ordinary skill in the art will appreciate that the present embodiment may be scalable to any size or angle.

In another example, intermediate surface 665 may be flat, and may be inclined with respect to an axis of symmetry of a light source (e.g., axis of symmetry 546 of light source 545 of FIG. 5). For example, the incline of surface 665 may be a positive incline or a negative incline. In another example, the incline of surface 665 may correspond to an incline of reflector 650 with respect to the axis of symmetry of the light source (e.g., incline 567 of FIG. 5). In another example, the incline may be between about −20 degrees and about 20 degrees (e.g., about −1 degrees).

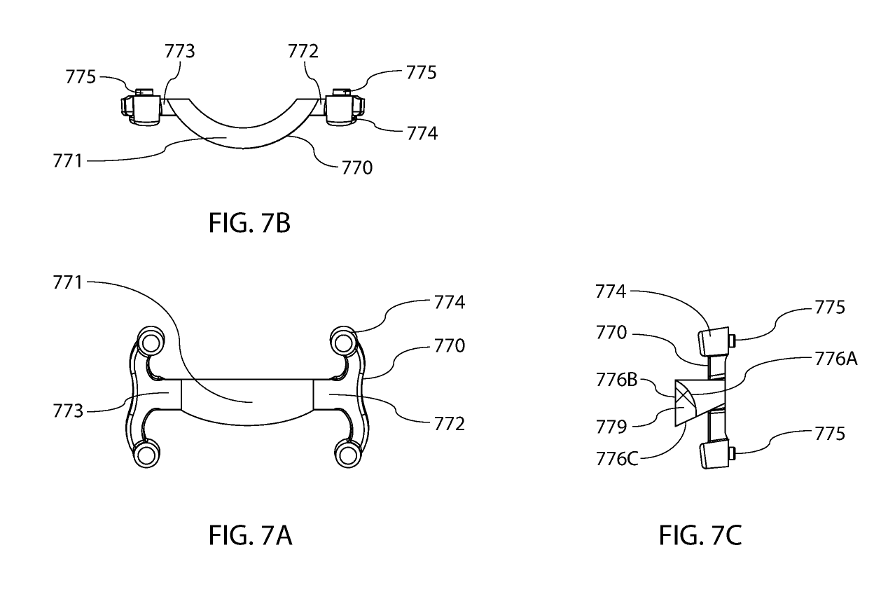

Reflector 650 may include one or more slots 649 extending therein to enable attachment with a lens (e.g., lens 770 of FIGS. 7A-7D). For example, slots 649 may extend into reflector 650 near the rearward perimeter 652, and may enable at least a portion of the lens to be inserted therein. A person of ordinary skill in the art will appreciate that an alternative means for attachment may include insertion of at least a portion of reflector 650 into a corresponding slot of the lens (not shown).

Reflector 650 may include one or more tabs 657 extending therefrom to enable attachment with one or more of a frame element (e.g., frame element 230 of FIG. 2), and/or an optic surround (e.g., optic surround 235 of FIG. 2). For example, tabs 657 may extend from reflector 650 near the forward perimeter 654.

FIGS. 7A-7C illustrate various views of a lens 770 for subtending light from a light source (e.g., light source 345 of FIG. 3). Lens 770 may have a refractive portion 771 capable of refracting light from the light source, and one or more arms (e.g., arms 772, 773) for enabling attachment with one or more of a reflector (e.g., reflector 650 of FIG. 6), and/or a PCBA (e.g., PCBA 541 of FIG. 5).

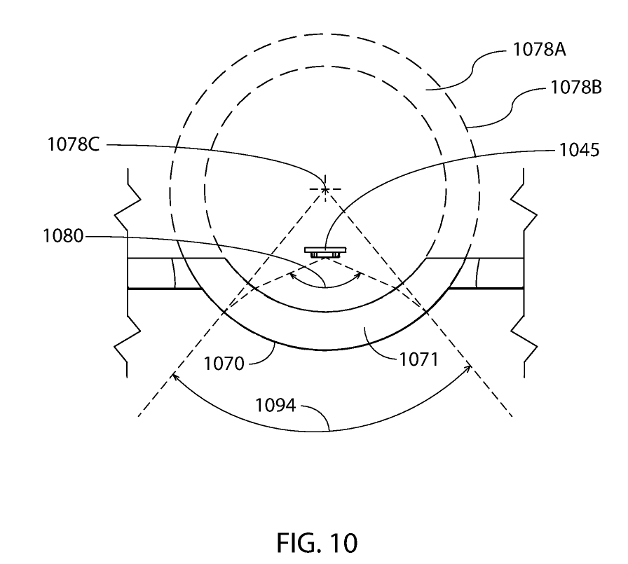

Refractive portion 771 may have a particular cross-sectional shape 779 to optimize refraction of light therethrough (e.g., as exemplified in FIGS. 5B and/or 7C). Furthermore, cross-sectional shape 779 may be extended along a straight and/or curved distance to create any one or more of a three-dimensional polygon (e.g., a wedge), a torus, an elliptic torus, a segment of a three-dimensional polygon, a segment of a torus (e.g., as exemplified in FIGS. 7A-7D), and/or a segment of an elliptic torus. For example, refractive portion 771 may extend around and/or across a light source (e.g., light source 345 of FIG. 3) in such a way that the distance from the light source to any point along the length of the refractive portion 771 is substantially equal (e.g., as exemplified in FIG. 8B). In another example, a span of light emitted from the light source (e.g., emitted span 1080 of FIG. 10) may travel substantially the same distance before passing into refractive portion 771. Light traveling a substantially equal length from the light source to the refractive portion 771 may be transmitted therethrough with a higher resolution, and/or may experience less distortion.

Refractive portion 771 may be formed by one or more surfaces (e.g., surfaces 776A-776C). For example, where refractive portion 771 is a toroid, refractive portion 771 may be formed by a toroidal surface. In another example, where refractive portion 771 is a segment of a toroid, refractive portion 771 may be formed by a toroidal surface 776A, a cylindrical surface 776B, and a planar surface 776C. A radius of toroidal surface 776A and/or the depth at which cylindrical surface 776B cuts into toroidal surface 776A may be selected to optimize collimation, focusing, and/or diffusion of light therethrough. The depth at which planar surface 776C cuts into toroidal surface 776A may be selected to enable a specified portion of light to pass below refractive portion 771 without being subtended thereby (e.g., spill light) and/or to prevent occurrence of any spill light.

Arms 772, 773 may each have at least one bulb (e.g., bulbs 774) to enable attachment with the reflector (e.g., reflector 650 of FIG. 6). For example, bulbs 774 may be insertable into slots of the reflector (e.g., slots 649 of reflector 650 of FIG. 6). A person of ordinary skill in the art will appreciate the reversible nature of bulbs 774 and slots of the reflector. In another example, arms 772, 773 may be bifurcated, such that at least two bulbs 774 may extend from a single arm (e.g., as exemplified in FIG. 7A). This configuration may enable enhanced stability with respect to the attachment between lens 770 and the reflector (e.g., reflector 650 of FIG. 6).

Each arm 772, 773 may have at least one pin (e.g., pins 775) to enable alignment and/or attachment with the PCBA (e.g., PCBA 541 of FIG. 5). For example pins 775 may be insertable into slots of the PCBA (not shown). A person of ordinary skill in the art will appreciate the reversible nature of pins 775 of lens 770 and slots of the PCBA. In another example, arms 772, 773 may be bifurcated, such that at least two pins 775 may extend from a single arm to enable enhanced stability with respect to the attachment between lens 770 and the PCBA. In another example, each pin 775 may extend from a corresponding bulb 774 (e.g., as exemplified in FIGS. 7B and 7C).

FIGS. 8A and 8B illustrate an optic assembly 840 secured to a frame element 830, according to another embodiment of the present invention. Optic assembly 840 may include a reflector 850 and a lens 870 positioned on a PCBA 841 to redirect light from a light source (e.g., light source 845 of FIG. 8B). Frame element 830 may be interconnected with reflector 850.

Reflector 850 may include one or more tabs 857 extending from reflector 850 for interconnection with one or more tabs 833 extending from frame element 830. For example, tabs 857 of reflector 850 may include one or more ribs 858 which may enable frame element 830 to be aligned with reflector 850. In another example, tabs 833 of frame element 830 may be interconnected with tabs 857 of reflector 850 by sliding tab 857 across tab 833 and/or between ribs 858 (e.g., such that opening 831 of frame element 830 may be aligned with opening 851 of reflector 850).

Tabs 857 of reflector 850 may include one or more teeth 859 which may extend into corresponding apertures 834 in tabs 833 of frame element 830 to further facilitate the interconnection between frame element 830 and reflector 850. For example, apertures 834 may extend at least partially through tabs 833 of frame element 830. In another example, apertures 834 may extend entirely through tabs 833 of frame element 830 (e.g., as exemplified in FIG. 8A). In another example, teeth 859 may extend at least partially into apertures 834 to prevent frame element 830 from disconnecting from reflector 850.

Tabs 833 of frame element 830 may deflect during interconnection with tabs 857 of reflector 850. For example, where at least two tabs 833 are positioned at opposing ends of frame element 830, one or both tabs 833 may deflect outwardly (e.g., away from each other) as they begin to contact and/or interconnect with tabs 857 of reflector 850. In another example, tabs 833 may reach a maximum deflection just prior to alignment of teeth 859 with apertures 834. In another example, tabs 833 may deflect inwardly (e.g., toward each other) when teeth 859 are aligned with apertures 834 (e.g., corresponding to interconnection). In another example, the inward deflection may be less than or equal to the outward deflection, such that tabs 833 of frame element 830 may be under an internal bias during interconnection with tabs 857 of reflector 850.

The internal bias may cause frame element 830 to be pushed away from reflector 850, whereas the interconnection of teeth 859 with apertures 834 may prevent frame element 830 from being pushed away from reflector 850. For example, an inner surface 838 of frame element 830 may be pushed away from a forward end 854 of reflector 850 (e.g., due to the internal bias). In another example, the inner surface 838 of frame element 830 and the forward end 854 of reflector 850 may be separated by a spacing 848. In another example, the inner surface 838 may be held at a maximum distance (e.g., spacing 848) from forward end 854 by teeth 859. The significance of spacing 848 is discussed in greater detail below.

In addition to the optic assembly 840 and frame element 830, FIG. 8B illustrates an optic surround 835 positioned adjacent frame element 830, such that one or more of optic surround 835, frame element 830, and optic assembly 840 may be compressed between a housing (e.g., housing 210 of FIG. 2) and a media 825 of a lighting fixture (e.g., lighting fixture 200 of FIG. 2). Optic surround 835, frame element 830, and/or optic assembly 840 may be compressed with a predetermined force and/or may be compressed a predetermined distance.

For example, where optic surround 835 and frame element 830 are formed integrally, they may hold substantially all of the predetermined force, and/or may be capable of deflecting the predetermined distance (e.g., via deflection of legs 837 of optic surround 835). In another example, where optic surround 835 and frame element 830 are formed separately, optic surround may hold substantially all of the predetermined force, and/or may be capable of deflecting the predetermined distance (e.g., via deflection of legs 837). In another example, frame element 830 may experience a substantially small portion of the predetermined force, and/or may be capable of deflecting up to the maximum distance (e.g., spacing 848). Thus, the predetermined force and/or predetermined distance of deflection may counteract the internal bias of tabs 833, such that inner surface 838 of frame element 830 may be compressed toward forward end 854 of reflector 850 (e.g., reducing spacing 848).

In accordance with the above discussion, some, none, or all of the predetermined force may be transferred to reflector 850. For example, frame element 830 may be capable of transferring the small and/or reduced portion of the predetermined force to reflector 850 to enable reflector 850 to be secured against one or more of lens 870, PCBA 841 and/or housing 810. In another example, frame element 830 may be capable of transferring the small portion of the predetermined force to reflector 850 without causing adverse deformation of reflector 850 from excessive force loads (e.g., preventing a deformation of the resulting beam pattern produced by light reflecting from reflector 850). In another example, inner surface 838 of frame element 830 may move toward forward end 854 of reflector 850 in response to the predetermined force until the predetermined force is counteracted by optic surround 835 and/or the housing (e.g., housing 210 of FIG. 2).

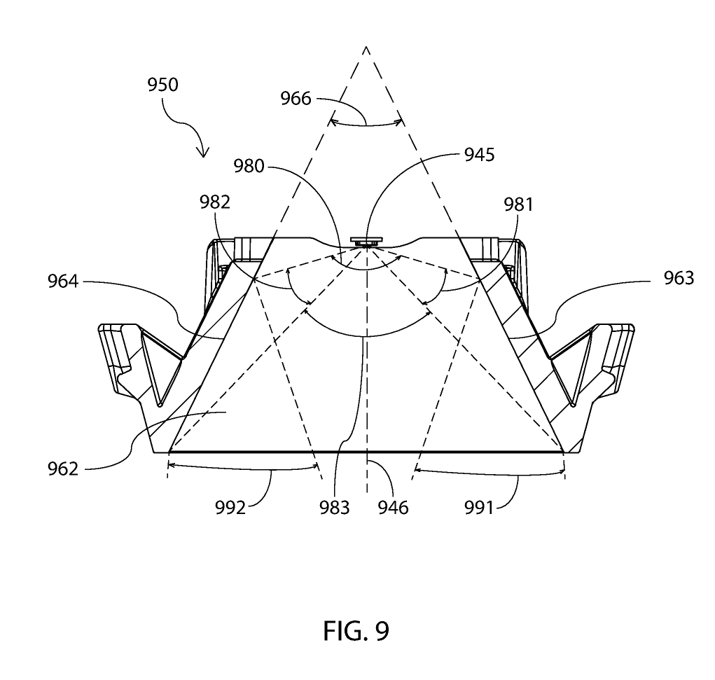

FIG. 9 illustrates a cross-sectional view of a reflector 950 showing light emitted by a light source 945 (e.g., an LED light source). Light source 945 may emit light in a span of emission 980 (e.g., a span including spans 981, 982, 983) corresponding to an axis of symmetry 946 extending through reflector 950. The span of emission 980 of light source 945 may be between about 120 degrees and about 220 degrees (e.g., about 180 degrees). Portions of the emitted light may be subtended (e.g., producing subtended spans 991, 992), and/or may pass from reflector 950 without being subtended (e.g., producing spill light).

For example, a first span 981 of emitted light 980 may be subtended (e.g., reflected) by a surface 963 of reflector 950, and may produce subtended span 991. In another example, a second span 982 of emitted light 980 may be subtended (e.g., reflected) by a surface 964 of reflector 950, and may produce subtended span 992. In another example, surface 963 may be configured separately from surface 964 and/or oppositely of axis of symmetry 946. In another example, a third span 983 of emitted light 980 may not be subtended by any surface (e.g., spill light). In another example, at least some of the third span 983 may be subtended by a surface 962. In another example, at least some of subtended spans 991, 992 may be further subtended by surface 962. In another example, subtended spans 991, 992 may be subtended toward the axis of symmetry 946 of light source 945.

Surfaces 962, 963, 964 may be flat, curved, convex, concave, spherical, parabolic, or any other suitable shape. For example, surface 962 may be parabolic. In another example, surfaces 963, 964 may be flat. In another example, surfaces 963, 964 may be one of parallel or angled with respect to each other (e.g., having an angle 966). In another example, surfaces 963, 964 may be mirrored across axis of symmetry 946. In another example, the angle of surface 963 with respect to axis of symmetry 946 may be equal to the angle of surface 964 with respect to axis of symmetry 946.

FIG. 10 illustrates a view of a refractive portion 1071 of a lens 1070 with a light source 1045 positioned to emit light therethrough (e.g., emitted span 1080). Refractive portion 1071 may be a three-dimensional polygon, a toroid, an elliptical toroid, and/or a segment of any one of a three-dimensional polygon, a toroid, and an elliptical toroid. For example, where refractive portion 1071 is a segment of a toroid 1078A (e.g., exemplified in phantom lines in FIG. 10), refractive portion 1071 may extend at least partially around a circumference 1078B of the toroid 1078A.

Emitted span 1080 may travel between light source 1045 and refractive portion 1071. Further, emitted span 1080 may be emitted within an angular range of emission. For example, emitted span 1080 may be emitted within an angular range of between about 120 degrees and about 220 degrees (e.g., about 180 degrees).

Light source 1045 may be positioned with respect to refractive portion 1071 to optimize subtending (e.g., refraction) of light therethrough. For example, toroid 1078A may include a center point 1078C, and light source 1045 may be positioned between center point 1078C and refractive portion 1071. For example, light source 1045 may be positioned between about 0.01 and about 0.99 times the distance between from center point 1078C to refractive portion 1071 (e.g., about 0.5 times the distance).

Positioning light source 1045 at some distance between center point 1078C and refractive portion 1071 may enable collimation, focusing, and/or diffusion of light subtended by refractive portion. For example, emitted span 1080 may be subtended by refractive portion 1071 to produce subtended span 1094. Subtended span 1094 may have an angular range of refraction that is less than, equal to, or greater than the angular range of emission of emitted span 1080. For example, where light source 1045 is positioned substantially at center point 1078C, the angular range of subtended span 1094 may be substantially similar to the angular range of emitted span 1080. In another example, where light source 1045 is positioned between center point 1078C and refractive portion 1071, the angular range of subtended span 1094 may be less than the angular range of emitted span 1080 (e.g., narrower). In another example, where light source 1045 is positioned behind center point 1078C with respect to refractive portion 1071, the angular range of subtended span 1094 may be greater than the angular range of emitted span 1080 (e.g., wider). Thus, light source 1045 may be positioned with respect to center point 1078C and refractive portion 1071 to optimize the angular range of subtended span 1094 (e.g., to produce a particular beam pattern and/or photometric distribution).

FIG. 11 illustrates an isocandela plot of a combined beam pattern 1101 produced by an optic assembly (e.g., optic assembly 340 of FIG. 3). The isocandela plot may have a width-wise axis (e.g., axis L-R), and a height-wise axis (e.g., axis D-U), with incremental values extending along each axis based on the angle from the axis of symmetry of a light source (e.g., axis of symmetry 546 of light source 545 of FIG. 5A) and/or based on a principal optical axis of an optic assembly (e.g., principal optical axis 577 of FIG. 5A). For example, the value 0 on both the L-R axis and the D-U axis may represent the point to which the axis of symmetry extends. In another example, the value 0 on both the L-R axis and the D-U axis may represent the point to which the principal optical axis extends. In another example, the value 5 on the L-R axis and -6 on the D-U axis represents a rightward rotation of 5 degrees and a downward rotation of 6 degrees from the axis of symmetry. Thus, a person of ordinary skill in the art will appreciate that combined beam pattern 1101 may extend between a range of values along the L-R axis, and between a range of values along the D-U axis.

Further, combined beam pattern 1101 may have a particular luminous intensity at each point along the L-R and D-U axes (e.g., a particular photometric distribution). The isocandela plot may incrementally represent luminous intensity by one or more bands (e.g., bands 1108, 1109). For example, a first band 1108 may represent a first luminous intensity (e.g., about 413 lumens), and may represent a boundary between luminous intensities below and above the first luminous intensity. In this example, points along the L-R and D-U axes and outside band 1108 may be less than the first luminous intensity, and points along the L-R and D-U axes and inside band 1108 may be greater than the first luminous intensity.

In another example, a second band 1109 may represent a second luminous intensity (e.g., about 826 lumens). In this example, points along the L-R and D-U axes and outside band 1109 may be less than the second luminous intensity, and points along the L-R and D-U axes and inside band 1109 may be greater than the second luminous intensity. Further, band 1109 may lie interior to and/or may be entirely enclosed by band 1108 (e.g., such that band 1109 represents a higher luminous intensity than band 1108). One or more additional bands (e.g., 16 or more additional bands) may lie interior to band 1109. Each subsequent interior band may represent an incrementally higher luminous intensity. In another example, the incremental increase in intensity of each band may be approximately similar.

Combined beam pattern 1101 may have an angular width 1187 extending along the L-R axis, and an angular height 1197 extending along the D-U axis (e.g., forming a region of luminous intensity as indicated by bands 1108, 1109, and any additional bands). For example, angular width 1187 may extend between about −60 degrees and about 60 degrees along the L-R axis (e.g., first band 1108 may extend between about −43 degrees and about 43 degrees). In another example, angular width 1187 may have a total span of between about 60 degrees and about 120 degrees (e.g., a width of first band 1108 may span about 86 degrees). In another example, angular height 1197 may extend between about 0 degrees and about −40 degrees along the D-U axis (e.g., first band 1108 may extend between about 0 degrees and about −28 degrees). In another example, angular height 1197 may have a total span of between about 14 degrees and about 40 degrees (e.g., a height of first band 1108 may span about 28 degrees).

Where combined beam pattern 1101 is associated with a particular application, the particular bounds (e.g., height and width) of combined beam pattern 1101 may be designed to satisfy industry and/or governmental standards (e.g., for a fog light application, to satisfy SAE J583 and ECE R19 standards). For example, combined beam pattern 1101 may have a uniform distribution of luminous intensity along width 1187 and/or height 1197. In another example, combined beam pattern 1101 may have a non-uniform distribution of luminous intensity along width 1187 and/or height 1197. In another example, discrete positions of combined beam pattern 1101 along the L-R and D-U axes may be at least above particular intensity values. In another example, discrete positions of combined beam pattern 1101 along the L-R and D-U axes may be at least below particular intensity values.

The distribution of luminous intensity of combined beam pattern 1101 may be described in terms of one or more beam patterns (e.g., beam patterns 1102-1104). For example, beam pattern 1102 may have a width 1188 extending along the L-R axis, and a height 1198 extending along the D-U axis. In another example, width 1188 of beam pattern 1102 may be less than or equal to width 1187 of combined beam pattern 1101, and height 1198 of beam pattern 1102 may be less than or equal to width 1197 of combined beam pattern 1101.

Further, width 1188 may be substantially greater than height 1198 (e.g., for a fog light application). For example, width 1188 may extend between about −60 degrees and about 60 degrees along the L-R axis (e.g., formed of bands extending between about −40 degrees and about 40 degrees). In another example, width 1188 may have a total span of between about 60 degrees and about 120 degrees (e.g., about 80 degrees). In another example, height 1198 may extend between about 0 degrees and about −40 degrees along the D-U axis (e.g., formed of bands extending between about 0 degrees and about −6 degrees). In another example, height 1198 may have a total span of between about 2 degrees and about 40 degrees (e.g., about 6 degrees).

In another example, beam pattern 1103 may have a width 1189 extending along the L-R axis, and a height 1199 extending along the D-U axis. For example, width 1189 of beam pattern 1103 may be less than or equal to width 1187 of combined beam pattern 1101, and height 1199 of beam pattern 1103 may be less than or equal to height 1197 of combined beam pattern 1101. In another example, width 1189 of beam pattern 1103 may be less than or equal to width 1188 of beam pattern 1102, and height 1199 of beam pattern 1103 may be greater than or equal to height 1198 of beam pattern 1102.

In another example, width 1189 may be substantially similar in dimension as height 1199 (e.g., approximately square, rectangular, trapezoid shaped, and/or polygon shaped). In another example, width 1189 may extend between about −60 degrees and about 60 degrees along the L-R axis (e.g., formed of bands extending between about −15 degrees and about 15 degrees). In another example, width 1189 may have a total span of between about 14 degrees and about 50 degrees (e.g., about 30 degrees). In another example, height 1199 may extend between about 0 degrees and about −40 degrees along the D-U axis (e.g., formed of bands extending between about 0 degrees and about −18 degrees). In another example, height 1199 may have a total span of between about 2 degrees and about 40 degrees (e.g., about 18 degrees).

In another example, beam pattern 1104 may have a width and a height corresponding to the width and height of combined beam pattern 1101 (e.g., width 1187 and height 1197). In another example, beam pattern 1104 may form a region of relatively low luminous intensity (e.g., having fewer bands indicating luminous intensity). In another example, low luminous intensity light falling within beam pattern 1104 may originate from an optic assembly (e.g., optic assembly 540 of FIG. 5), and may be the result of light passing from the optic assembly without being subtended by either a reflector (e.g., reflector 550 of FIG. 5) or a lens (e.g., lens 570 of FIG. 5) of the optic assembly.

Beam pattern 1102 may form a region of relatively high luminous intensity (e.g., having a high number of bands indicating luminous intensity). High luminous intensity light falling within beam pattern 1102 may originate from the optic assembly (e.g., optic assembly 540 of FIG. 5), and may be the result of light subtended by a reflector and/or a lens (e.g., reflector 550 of FIG. 5). Beam pattern 1103 may form a region of relatively high luminous intensity (e.g., having a high number of bands indicating luminous intensity). High luminous intensity light falling within beam pattern 1103 may originate from the optic assembly (e.g., optic assembly 540 of FIG. 5), and may be the result of light subtended by a reflector and/or a lens (e.g., lens 570 of FIG. 5). Further, beam pattern 1103 may at least partially overlap with beam pattern 1102 (e.g., a region of overlap 1196), such that the region of overlap 1196 may have a substantially higher luminous intensity than either beam pattern 1102 and/or beam pattern 1103 individually.

In accordance with the above principles, each of beam patterns 1102-1104 may be formed by one or more components of the optic assembly, and may collectively form combined beam pattern 1101. For example, each beam pattern 1102-1104 may be designed so that combined beam pattern 1101 may satisfy industry and/or governmental standards (e.g., SAE J583 and ECE R19, for fog lights). In another example, combined beam pattern 1101 may be of particular use in fog light applications. Nevertheless, a person of ordinary skill in the art will appreciate that producing an altogether different combined beam pattern may be possible by adjusting one or more of the features of the present invention.

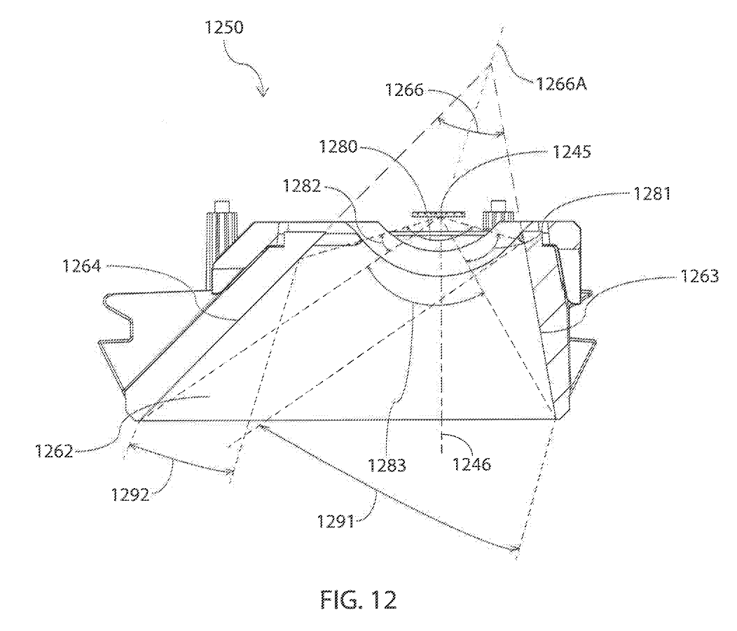

FIG. 12 illustrates a cross-sectional view of a reflector 1250 showing light emitted by a light source 1245 (e.g., a point light source). Light source 1245 may emit light in a span of emission 1280 (e.g., a span including spans 1281, 1282, 1283) corresponding to an axis of symmetry 1246 extending through reflector 1250. The span of emission 1280 of light source 1245 may be between about 120 degrees and about 220 degrees (e.g., about 180 degrees). Portions of the emitted light may be subtended (e.g., producing subtended spans 1291, 1292), and/or may pass from reflector 1250 without being subtended (e.g., producing spill light).

For example, a first span 1281 of emitted light 1280 may be subtended (e.g., reflected) by a surface 1263 of reflector 1250, and may produce subtended span 1291. In another example, a second span 1282 of emitted light 1280 may be subtended (e.g., reflected) by a surface 1264 of reflector 1250, and may produce subtended span 1292. In another example, surface 1263 may be configured separately from surface 1264 and/or oppositely of axis of symmetry 1246. In another example, a third span 1283 of emitted light 1280 may not be subtended by any surface (e.g., spill light). In another example, at least some of the third span 1283 may be subtended by a surface 1262. In another example, at least some of subtended spans 1291, 1292 may be further subtended by surface 1262. In another example, subtended spans 1291, 1292 may be subtended toward the axis of symmetry 1246 of light source 1245.

Surfaces 1262, 1263, 1264 may be flat, curved, convex, concave, spherical, parabolic, or any other suitable shape. For example, surface 1262 may be parabolic. In another example, surfaces 1263, 1264 may be flat. In another example, surfaces 1263, 1264 may be one of parallel or angled with respect to each other (e.g., having an angle 1266). In another example, surfaces 1263, 1264 may be mirrored across a plane of symmetry 1266A extending between surfaces 1263, 1264. In another example, plane of symmetry 1266A may be inclined with respect to axis of symmetry 1246. In another example, the angle of surface 1263 with respect to axis of symmetry 1246 may be less than the angle of surface 1264 with respect to axis of symmetry 1246. In another example, subtended and spill light may be passed substantially in a direction that is inclined with respect to axis of symmetry 1246 (e.g., leftward as it exits reflector 1250, which may correspond to a rightward path of travel of light from lighting fixture 200 of FIG. 2, or a rightward path of travel from vehicle 105 of FIG. 1), which may result in a beam pattern and/or photometric distribution off-center from the axis of symmetry 1246 (e.g., similar to beam pattern 1101 of FIG. 11, but offset from a center of the L-R axis).

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. A lighting system, comprising:
a reflector having at least one surface forming an interior, the reflector having a forward opening and a rearward opening;
a light source configured at the rearward opening to emit light through the interior of the reflector; and
a lens configured at the rearward opening, wherein the lens is formed of a segment of a toroid.

2. The lighting system of claim 1, wherein the light source is an LED light source.

3. The lighting system of claim 1, wherein the lens has a particular cross-sectional shape configured to subtend at least a portion of the emitted light so that a principal optical axis of the lens is inclined with respect to an axis of symmetry of the light source.

4. The lighting system of claim 1, wherein the lens is formed by one or more of a toroidal surface, a cylindrical surface, and a planar surface.

5. The lighting system of claim 4, wherein the lens is formed by a toroidal surface, a cylindrical surface, and a planar surface.

6. The lighting system of claim 1, wherein the at least one surface of the reflector includes first, second, third, fourth, and fifth surfaces forming the interior, and wherein light emitted by the light source is subtended by one or more of the first, second, third, fourth, and fifth surfaces and the lens.

7. The lighting system of claim 1, wherein the lighting system includes a housing, the reflector coupled to the housing, a frame element coupled to the reflector, and a media extending over the reflector, wherein the media exerts a force on the frame element, and wherein the frame element moves with respect to the reflector in response to the force.

8. A lighting system, comprising:
a reflector having first, second, third, fourth, and fifth surfaces forming an interior, the reflector having a forward opening and a rearward opening;
a light source configured at the rearward opening to emit light through the interior of the reflector; and
a lens configured at the rearward opening, wherein light emitted by the light source is subtended by one or more of the first, second, third, fourth, and fifth surfaces and the lens.

9. The lighting system of claim 8, wherein at least one of the first, second, third, fourth, and fifth surfaces extend from the forward opening to the rearward opening.

10. The lighting system of claim 9, wherein the second, third, and fourth surfaces extend from the forward opening to the rearward opening.

11. The lighting system of claim 9, wherein the first surface extends less than the distance from the forward opening to the rearward opening, and the fifth surface extends the remainder of the distance.

12. The lighting system of claim 8, wherein the first and second surfaces are configured oppositely, and wherein the first and second surfaces are formed by a parabola projected along a distance to form a parabolic trough having a principal focal axis extending along the distance, and a plane of symmetry extending between the first and second surfaces.

13. The lighting system of claim 12, wherein the plane of symmetry is inclined with respect to an axis of symmetry of the light source.

14. The lighting system of claim 12, wherein the principal focal axis is offset with respect to an axis of symmetry of the light source.

15. The lighting system of claim 8, wherein the third fourth and fifth surfaces are each formed by one or more of a flat surface, a concave surface, and a convex surface.

16. The lighting system of claim 8, wherein the third and fourth surfaces are angled with respect to each other.

17. The lighting system of claim 16, wherein the third and fourth surfaces are configured oppositely of a plane of symmetry extending between the third and fourth surfaces.

18. The lighting system of claim 17, wherein the plane of symmetry is inclined with respect to an axis of symmetry of the light source.

19. The lighting system of claim 8, wherein the lens is formed of a segment of a toroid.

20. The lighting system of claim 8, wherein the lighting system includes a housing, the reflector coupled to the housing, a frame element coupled to the reflector, and a media extending over the reflector, wherein the media exerts a force on the frame element, and wherein the frame element moves with respect to the reflector in response to the force.

21. A lighting system, comprising:
a housing;
a reflector coupled to the housing;
a frame element coupled to the reflector; and
a media extending over the reflector, wherein the media exerts a force on the frame element, and wherein the frame element moves with respect to the reflector in response to the force.

22. The lighting system of claim 21, wherein the reflector has at least one surface forming an interior, the reflector having a forward opening and a rearward opening, the lighting system further including a light source configured at the rearward opening to emit light through the interior of the reflector, and a lens configured at the rearward opening, wherein the lens is formed of a segment of a toroid.

23. The lighting system of claim 21, wherein the reflector has first, second, third, fourth, and fifth surfaces forming an interior, the reflector having a forward opening and a rearward opening, the lighting system further including a light source configured at the rearward opening to emit light through the interior of the reflector, and a lens configured at the rearward opening, wherein light emitted by the light source is subtended by one or more of the first, second, third, fourth, and fifth surfaces and the lens.
